(19) United States
(12) Patent Application Publication
(10) Pub. No.: US 2014/0193323 A1
(43) Pub. Date: Jul. 10, 2014

(54) Double Wall Carbon Nanotubes and Method for Manufacturing Same

(71) Applicant: Cheil Industries Inc., Gumi-si (KR)

(72) Inventors: Kyoung Tae Youm, Uiwang-si (KR); Byeong Yeol Kim, Uiwang-si (KR); Young Sil Lee, Uiwang-si (KR); Bo Kyung Lim, Uiwang-si (KR)

(21) Appl. No.: 14/238,234

(22) PCT Filed: Nov. 2, 2012
(86) PCT No.: PCT/KR2012/009185

§ 371 Date: Feb. 11, 2014

(30) Foreign Application Priority Data
Nov. 4, 2011 (KR) 10-2011-0114671

(51) Int. Cl. C01B 31/02

(52) U.S. Cl. CPC C01B 31/0233; C01B 31/022
USPC 423/447.2; 423/447.3

(57) ABSTRACT

The present invention relates to a method for manufacturing carbon nanotubes comprising: a preparatory step of a supported catalyst; a temperature-raising step of inserting the supported catalyst into a reactor, injecting hydrocarbon gas and hydrogen gas at the same time, and raising the temperature of the reactor to between 900 to 1000° C. to synthesize carbon nanotubes; and a temperature-lowering step of lowering the temperature of the reactor to between a room temperature to 200° C., injecting only hydrogen gas, and synthesizing carbon nanotubes. The carbon nanotubes manufactured by the above method have high purity, and excellent selectivity for double wall carbon nanotubes can be achieved.

### FIELD OF THE INVENTION

The present invention relates to double-wall carbon nanotubes. More particularly, the present invention relates to double-wall carbon nanotubes that have high purity, excellent selectivity for double-wall carbon nanotubes of synthesized carbon nanotubes, a few defects, and high crystallinity, and to a method for manufacturing the same. The present invention comprises a supported catalyst that has an excellent synthesis yield for manufacturing the double-wall carbon nanotubes of the present invention.

### BACKGROUND OF THE INVENTION

A carbon nanotube is a carbon allotrope around which is wound by a graphite plate in a cylinder form having a nano-sized diameter, wherein the graphite plate has a hexagonal beehive structure made of sp² carbon. The circumference of the carbon nanotube is based on only several tens of carbon atoms, but the length thereof is several micrometers. Thus, the carbon nanotube appears an ideal one-dimensional structure having high aspect ratio. This structure ensures the excellent mechanical, electrical, magnetic, optical, and thermal properties of carbon nanotubes.

Carbon nanotubes are classified into single-wall nanotubes (SWNT) having one wall, double-wall nanotubes (DWNT) having two walls, and multi-wall nanotubes (MWNT) having three or more walls. Above all, the double-wall carbon nanotubes appear strong points of the single-wall nanotubes and the multi-wall nanotubes at the same time, thus they are used for electronic elements, high strength complex materials for sensors, and the like.

Since carbon nanotubes are conventionally expensive, it is required that carbon nanotubes are cost-effectively synthesized in a mass-production manner in order to be usefully applied to various fields. However, in order to obtain desired electric conductivity using a little content of carbon nanotubes, the characteristic of carbon nanotubes themselves has to be considered in addition to the characteristic of resins and processing conditions. Also, carbon nanotubes having high purity and productivity are required, and the development of catalysts for the same is important.

A method for synthesizing carbon nanotubes comprises conventionally an electrical discharging method, a laser deposition method, a high pressure evaporation method, an atmospheric pressure thermochemical evaporation method, and the like. Above all, the electrical discharging method and the laser deposition method are applicable based on their simple principles, but impurities are highly generated during the synthesis and they are not applicable for mass-production.

Otherwise, a thermochemical vapor deposition method has been well-known as a method for cost-effectively synthesizing high purity carbon nanotubes in a mass-production manner. The thermochemical vapor deposition method has various kinds of products and raw materials, is applicable for synthesizing high purity materials, and controls micro-structures. However, the yield of double-wall carbon nanotubes is very low and the diameters of the synthesized carbon nanotubes become irregular when the double-wall carbon nanotubes are synthesized based on the known thermochemical vapor deposition method.

Korean Patent Publication No. 2007-71177 discloses a method for synthesizing single-wall carbon nanotubes using a glass substrate in order to improve uniformity in diameters of carbon nanotubes. However, this method requires complex processes such as a buffer layer deposition process and a catalyst metal deposition process, and a device for maintaining vacuum state.

Catalysts are important in synthesizing nanotubes based on the thermochemical vapor deposition method, since the growth of carbon nanotubes is varied according to the kinds and composition ratios of transition metals, and the sizes of metal particles. Fe, Co, Ni, and the like are used as the transition metals and are synthesized by being supported in a support. The synthesizing method comprises a coprecipitation method or an impregnation method. The coprecipitation method uniformly dissolves catalyst materials in an aqueous solution and supports the product in a support by adjusting the pH thereof The impregnation method dries the dissolved solution and polishes the product in order to uniformly support metal catalysts, and then calcining the product to be synthesized at high temperatures between 700 and 900° C. for a long period of time within 6-10 hours. However, these methods take long time and achieve low yields, thus they are not applicable for mass-production.

Accordingly, the present inventors have developed a method for synthesizing high purity double-wall carbon nanotubes by specifying synthesis conditions such as the kinds and amount of injection gases, and synthesis temperatures during the synthesis of carbon nanotubes.

### DETAILED DESCRIPTION OF THE INVENTION

### Technical Subject

The present invention provides a novel method for manufacturing carbon nanotubes using a supported catalyst that can have an excellent synthesis yield of carbon nanotubes.

The present invention also provides a method for manufacturing high purity carbon nanotubes.

The present invention further provides a method for manufacturing carbon nanotubes that can have high selectivity to double-wall carbon nanotubes of synthesized carbon nanotubes.

The present invention further provides a method for manufacturing carbon nanotubes that can have a few defects and high crystallinity.

The present invention further provides a novel supported catalyst used for manufacturing carbon nanotubes according to the present invention.

The aforementioned and other objects of the present invention will be achieved by the present invention as described below.

### Technical Solution

A method for manufacturing carbon nanotubes in accordance with the present invention comprises a preparatory step of a supported catalyst; a temperature-raising step of inserting the supported catalyst into a reactor, injecting hydrocarbon gas and hydrogen gas at the same time, and raising the temperature of the reactor to between 900 to 1000° C. to synthesize carbon nanotubes; and a temperature-lowering step of lowering the temperature of the reactor to a room temperature to 200° C., injecting only hydrogen gas, and synthesizing carbon nanotubes.

The supported catalyst is manufactured by calcining an aqueous catalyst solution in a reaction at the temperature of between 500 to 800° C. for 20 to 60 minutes, wherein the aqueous catalyst solution is the mixture of a metal catalyst and a support at the molar ratio as below.

Support [Mg]:Metal catalyst [Co]:Molybdenum-based activator [Mo]=0.99:x:0.025

(Wherein, 0.05≦x≦0.075)

The supported catalyst is manufactured by supporting a metal catalyst in a porous amorphous support, wherein the size of the metal catalyst is preferably less than or equal to 5 nm. The supported catalyst whose surface area is increased by grinding the calcined supported catalyst can be used.

In the temperature-raising step, carbon nanotubes are synthesized by injecting hydrocarbon gas and hydrogen gas while the temperature of the reactor is raised to between 900 to 1000° C. and is maintained for 30 to 90 minutes. The hydrocarbon gas is injected at the speed of 200 to 300 sccm, and the hydrogen gas is injected at the speed of 700 to 900 sccm. The hydrocarbon is methane, ethylene, acetylene, LPG, or a mixed gas thereof.

In the temperature-lowering step, the hydrogen gas is injected at the speed of 700 to 900 sccm.

The yield according to the method for manufacturing double-wall carbon nanotubes in accordance with the present invention is 100% or more per 1 g of the supported catalyst. The purity (C-purity) of carbon nanotubes, manufactured by the above-mentioned method, is more than or equal to 50%, the intensity ratio of D band to G band (ID/IG) thereof through raman spectroscopy is less than 0.15, and there are 2 peaks in a pair in the range of an RBM mode.

The present invention will be described in detail from the following detailed description with reference to the accompanying drawings.

### Effect of the invention

A method for manufacturing double-wall carbon nanotubes in accordance with the present invention can provide carbon nanotubes that have high purity, high selectivity to double-wall carbon nanotubes of synthesized carbon nanotubes, a few defects, and high crystallinity using a supported catalyst having an excellent synthesis yield.

### BRIEF DESCRIPTION OF THE DRAWINGS

FIG. 1 is a TEM image which photographs the cross-section of the supported catalyst according to the present invention.

FIG. 2 is an SEM image of the carbon nanotube manufactured according to Example 1.

FIG. 3 is a TEM image of the carbon nanotube manufactured according to Example 1.

FIG. 4(a) is a raman spectroscopic graph of the carbon nanotube manufactured according to Example 1, and FIG. 4(b) is the expanded image of the RBM area in the raman spectroscopic graph.

FIG. 5 is a raman spectroscopic graph of the carbon nanotube manufactured according to Comparative Example 1.

### OPTIMAL EMBODIMENT OF THE PRESENT INVENTION

The present invention relates to double-wall carbon nanotubes and relates to a method for manufacturing double-wall carbon nanotubes that have high purity, high selectivity to double-wall carbon nanotubes of synthesized carbon nanotubes, a few defects, and high crystallinity.

Method for Manufacturing Double-Wall Carbon Nanotubes

A method for manufacturing double-wall carbon nanotubes in accordance with the present invention is to manufacture double-wall carbon nanotubes having high quality and uniform diameters based on a thermochemical vapor deposition method. Specifically, the method for manufacturing double-wall carbon nanotubes comprises a preparatory step of a supported catalyst, a step of injecting the supported catalyst in a reactor, injecting hydrocarbon gas and hydrogen gas, and raising the temperature of the reactor, and a step of injecting only hydrogen gas and lowering the temperature of the reactor. Hereinafter, each step will be precisely described.

(A) Preparatory step of a supported catalyst In the preparatory step of a supported catalyst of the present invention, an aqueous catalyst solution, the mixture of a metal catalyst and a support, is prepared, the aqueous catalyst solution is arranged in a boat, and the metal catalyst and the support are calcined in the reactor at the same time, and then metal catalyst particles are supported in the pores of the support.

The supported catalyst of the present invention preferably has the molar ratio as below. When the molar ratio of the supported catalyst is within the range as below, the content of double-wall carbon nanotubes can be 50% or more, preferably 60% or more, more preferably 70% or more based on the content of synthesized carbon nanotubes.

Support (Mg):Metal catalyst (Co):Molybdenum-based activator (Mo)=0.99:x:0.025

(Wherein, x is between 0.05 and 0.075)

The present invention prevents nano-sized metal catalysts from being agglomerated during the calcining process at high temperatures by injecting a molybdenum-based activator such as ammonium molybdate tetrahydrate into the supported catalyst. Citric acid can be used as the activator.

The metal catalyst and the support are respectively dissolved in water to be mixed in an aqueous phase. The aqueous catalyst solution, in which the metal catalyst and the support are mixed, is completely dissociated by stirring.

After the stirring is completed, the metal catalyst and the support are calcined. The aqueous catalyst solution containing the metal catalyst and the support is arranged in a boat and is calcined in the reactor at the temperature of 500 to 800° C. for 20 to 90 minutes, preferably 20 to 60 minutes. Processes for forming metal catalyst particles and supporting a base body are simultaneous conducted through the calcining process. Thus, the catalyst is formed in a short period of time.

The supported catalyst of the present invention is a metal catalyst supported in a porous amorphous support. The size of the metal catalyst is preferably less than or equal to 5 nm. FIG. 1 shows a TEM image which photographs the cross-section of one supported catalyst in accordance with the present invention.

The supported catalyst of the present invention can be ground or pulverized in order to widen the surface area of the catalyst.

(B) Temperature-Raising Step

In the temperature-raising step for synthesizing carbon nanotubes, the manufactured supported catalyst is injected into the reactor, and then hydrocarbon gas and hydrogen gas are injected into the reactor at the same time. The temperature of the reactor is raised to between 900 to 1000° C. to synthesize carbon nanotubes. During the temperature-raising step, the temperature of the reactor is raised to between 900 to 1000° C. and is maintained for 30 to 90 minutes to synthesize carbon nanotubes.

In the temperature-raising step, reduction of metal catalysts and termination of catalyst reactions are suppressed, and synthesis of carbon nanotubes is continued by injecting hydrocarbon gas and hydrogen gas at the same time. During the temperature-raising step, the preferable injecting speed of hydrocarbon gas is 200 to 300 sccm, and the preferable injecting speed of hydrogen gas is 700 to 900 sccm.

Methane, ethylene, acetylene, LPG, or a mixed gas thereof can be used as the hydrocarbon gas, but not limited to the same.

(C) Temperature-Lowering Step

The temperature-lowering step for synthesizing carbon nanotubes synthesizes carbon nanotubes by injecting only hydrogen gas into the carbon nanotubes after the temperature-raising step, and lowering the temperature of the reactor from a room temperature to 200° C. During the temperature-lowering step, only hydrogen gas is injected to remove a carbon supplying source. The preferable injecting speed of the hydrogen gas is 700 to 900 sccm in the temperature-lowering step.

Double-Wall Carbon Nanotube

According to the above-mentioned method, double-wall carbon nanotubes having high purity can be manufactured, wherein the content of double-wall carbon nanotubes is more than or equal to 50% based on the entire content of the carbon nanotubes. The yield in accordance with the method for manufacturing double-wall carbon nanotubes can be 100% or more, preferably 150% per 1 g of the supported catalyst.

The orientation and the crystallinity of carbon nanotubes can be confirmed using a raman spectroscopy meter which sensitively reacts with difference in the orientation of C—C bonds, since the entire synthesized carbon nanotubes consist of C—C bonds and only orientation thereof is different. The intensity ratio of D band to G band (ID/IG) through raman spectroscopy of the carbon nanotubes of the present invention can be less than 0.15, preferably less than 0.12, more preferably less than 0.1. Also, the carbon nanotubes of the present invention are double-wall carbon nanotubes having 2 peaks in a pair in the area of an RBM mode.

FIG. 4 is the raman spectroscopic graph of carbon nanotubes manufactured by Example 1. (b) shows the expansion of the RBM area of (a). As shown on the FIG. 4, the crystallinity of carbon nanotubes can be shown using the intensity ratio of G band appeared in the 1580 cm⁻¹ area and D band appeared around 1350 cm⁻¹. The lesser intensity ratio of the

D band to the G band through raman spectroscopy (ID/IG), the fewer defects in carbon nanotubes and the higher crystallinity thereof The RBM mode appeared below 400 cm⁻¹ is a peak with respect to the diameters of carbon nanotubes. Conventionally, single-wall carbon nanotubes show only one peak, otherwise it is recognized that double-wall carbon nanotubes have two walls, thus specific 2 peaks in a pair are appeared.

The double-wall carbon nanotubes of the present invention can further comprise supported catalysts as below. The supported catalyst of the present invention is a metal catalyst supported in a porous amorphous support, wherein the size of the metal catalyst is preferably less than or equal to 5 nm.

Support [Mg]:Metal catalyst [Co]:Molybdenum-based activator [Mo]=0.99:x:0.025

(Wherein, 0.05≦x≦0.075)

The present invention will be further comprehensive in the following examples, which are intended for the purposed of illustration and are not be construed as in any way limiting the scope of the present invention

### EMBODIMENT OF THE PRESENT INVENTION

### EXAMPLE

### Example 1

2.534 g of a magnesium raw material and 1.9 g of a citric acid raw material were dissolved in 10 ml of deionized water. 0.22 g of a cobalt raw material was dissolved therein. While 0.044 g of a molybdenum raw material was added therein, and stirring was conducted (Molar ratio Mg:Co:Mo=0.99:0.075:0.025). After a metal catalyst particle solution was uniformly dissolved, the solution arranged on a boat was loaded in an oven whose temperature was maintained at 550° C. It was maintained at 550° C. for 20 minutes, and metal catalyst particles and a support were simultaneously calcined to support the metal catalyst particles in the pores of the support. Then, base powder containing the calcined metal catalyst was slightly ground to widen the surface area of the metal catalyst particles.

0.03 g of the manufactured metal catalyst particles arranged on the board was loaded in a reactor. While the internal temperature of the reactor was raised to 1000° C., and 200 sccm of methane as hydrocarbon gas and 800 sccm of hydrogen gas were injected. When the internal temperature of the reactor was reached to 1000° C., the temperature was maintained for 30 minutes. After the synthesis time for 30 minutes, methane gas was removed. The temperature of the reactor was lowered while 800 sccm of hydrogen gas was injected.

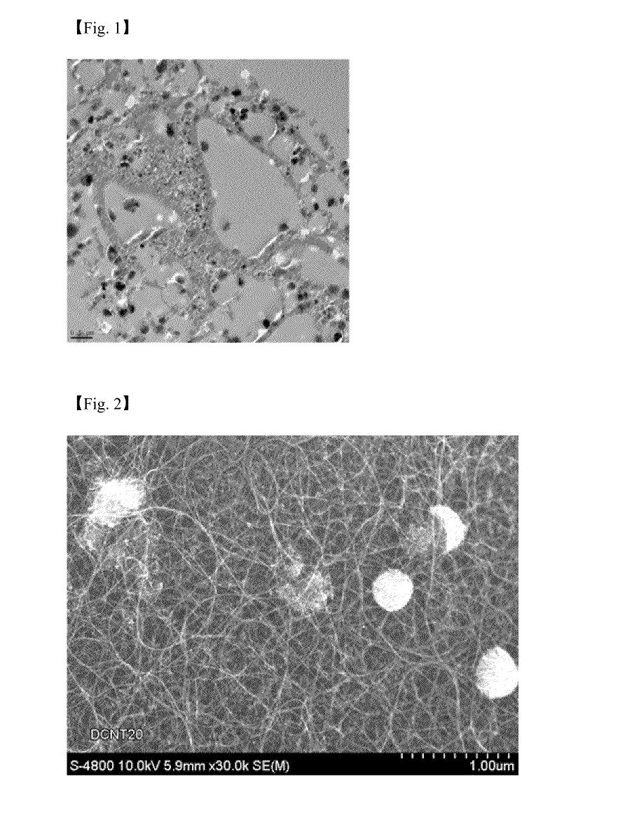

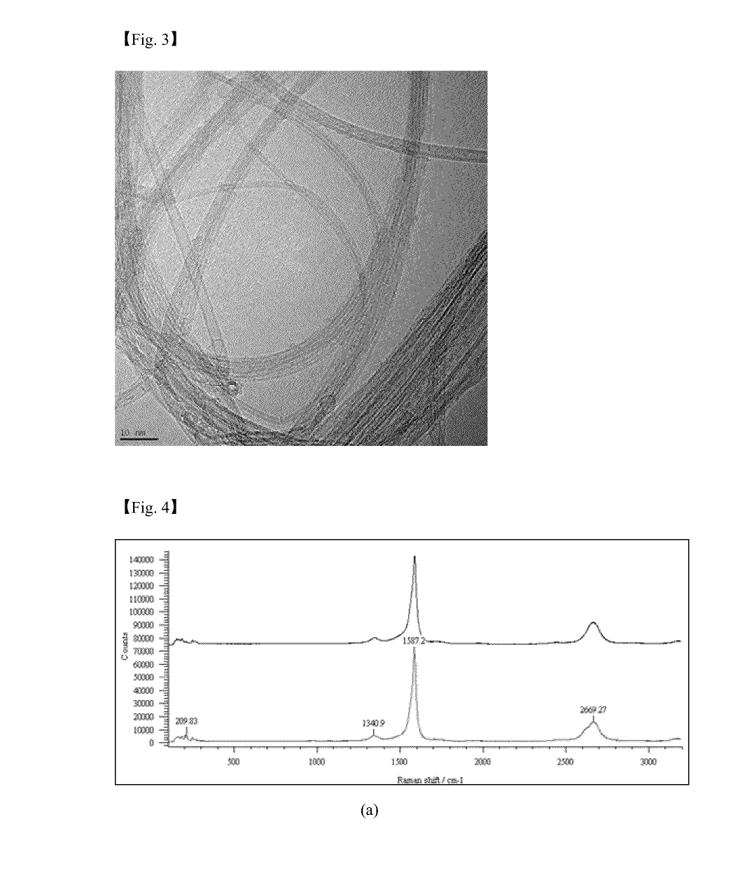

An SEM image and a TEM image of the double-wall carbon nanotubes are photographed and respectively shown on FIGS. 2 and 3. A raman spectroscopy is used for measuring for the crystallinity of the manufactured carbon nanotubes, and a thermogravimetric analyzer is used for measuring for the purity of carbon. Raman spectroscopy confirms that the intensity of D band to G band (ID/IG) is 0.0712, and there are peaks in a pair, features of double-wall carbon nanotubes, in an RBM mode area.

### Example 2

2.534 g of a magnesium raw material and 1.9 g of a citric acid raw material were dissolved in 10 ml of deionized water. 0.147 g of a cobalt raw material was dissolved therein. While 0.044 g of a molybdenum raw material was added therein, stirring was conducted (Molar ratio Mg:Co:Mo=0.99:0.05:0.025). After a metal catalyst particle solution was uniformly dissolved, the solution arranged on a boat was loaded in an oven whose temperature was maintained at 550° C. It was maintained at 550° C. for 20 minutes, and metal catalyst particles and a support were simultaneously calcined to support the metal catalyst particles in the pores of the support. Then, base powder containing the calcined metal catalyst was slightly ground to widen the surface area of the metal catalyst particles.

Then, 0.03 g of the manufactured metal catalyst particles arranged on the board was loaded in a reactor. The internal temperature of the reactor was raised to 900° C., and 200 sccm of methane as hydrocarbon gas and 800 sccm of hydrogen gas were injected. When the internal temperature of the reactor was reached to 900° C., the temperature was maintained for 60 minutes. After the synthesis time for 60 minutes, methane gas was removed. The temperature of the reactor was lowered while 800 sccm of hydrogen gas was injected.

### Example 3

The same synthesis was conducted as example 2 except for arranging 0.03 g of metal catalyst particles the same as example 1 on the boat, and then loading them in the reactor.

### Example 4

After arranging 0.03 g of metal catalyst particles the same as example 1, it was loaded in the reactor. 200 sccm of methane as hydrocarbon gas and 800 sccm of hydrogen gas were injected while the internal temperature of the reactor was raised to 900° C. When the internal temperature of the reactor reached to 900° C., the temperature was maintained for 90 minutes. After the synthesis time for 90 minutes, methane gas was removed. The temperature of the reactor was lowered while 800 sccm of hydrogen gas was injected.

### Example 5

2.534 g of a magnesium raw material and 1.9 g of a citric acid raw material were dissolved in 10 ml of deionized water. 0.22 g of a cobalt raw material was dissolved therein. While 0.044 g of a molybdenum raw material was added therein, stirring was conducted (Molar ratio Mg:Co:Mo=0.99:0.075:0.025). After a metal catalyst particle solution was uniformly dissolved, the solution arranged on a boat was loaded in an oven whose temperature was maintained at 550° C. It was maintained at 550° C. for 30 minutes, and metal catalyst particles and a support were simultaneously calcined to support the metal catalyst particles in the pores of the support. Then, base powder containing the calcined metal catalyst was slightly ground to widen the surface area of the metal catalyst particles. A synthesis process was the same as example 1.

### Comparative Example 1

2.534 g of a magnesium raw material and 1.9 g of a citric acid raw material were dissolved in 10 ml of deionized water. 0.367 g of a cobalt raw material was dissolved therein. While 0.044 g of a molybdenum raw material was added therein, stirring was conducted (Molar ratio Mg:Co:Mo=0.99:0.125:0.025). Subsequent serial processes were the same as example 1.

### Comparative Example 2

After arranging 0.03 g of metal catalyst particles the same as example 1 on a boat, it was loaded in the reactor. 500 sccm of argon gas, one of inert gas, was injected while the internal temperature of the reactor was raised to 1000° C. When the internal temperature of the reactor reached to 1000° C., argon gas was removed. 200 sccm of methane as hydrocarbon gas and 800 sccm of hydrogen gas were injected. The reactor was maintained at the temperature of 1000° C. for 30 minutes, and then the injection of methane gas and hydrogen gas was stopped. The temperature of the reactor was lowered while 500 sccm of argon gas was injected.

### Comparative Example 3

2.534 g of a magnesium raw material and 1.9 g of a citric acid raw material were dissolved in 10 ml of deionized water. 0.303 g of an iron raw material was dissolved therein. While 0.044 g of a molybdenum raw material was added therein, stirring was conducted (Molar ratio Mg:Fe:Mo=0.99:0.075:0.025). Subsequent serial processes were the same as example 1.

Specific Description of Each Component Used for the Examples

Magnesium raw material: Mg(NO₃)₂.6H₂O, Sigma Aldrich

Cobalt raw material: Co(NO₃)₂.6H₂O

Citric acid raw material: C₆H₈O₇.H₂O (Citric acid monohydrate, 99.5%), Samchun chemical

Molybdenum raw material: NH₄.6Mo₇O₂₄.4H₂O (Ammonium molybdate 99.6%), Samchun chemical

Measurement Method

SEM is measured using S-4800 of HITACHI Corporation.

TEM is measured using Field Emission Transmission Electron Microscopy.

TGA: C purity and D/G ratio are measured using a Q5000IR thermogravimetric analyzer of TA instrument Corporation.

A yield per 1 g of a catalyst (%) is calculated based on (Total weight—the weight of used catalyst)/(the weight of used catalyst)*100

The following table 1 shows the catalyst composition and reaction condition of examples and comparative examples, and following table 2 shows the purity (C-purity), D/G ratio, and the resultant value of a yield (%) per 1 g of a catalyst of carbon nanotubes manufactured by the examples and the comparative examples.

TABLE 1

| | | Catalyst thermal | | Synthesis | Synthesis |
|---|---|---|---|---|---|
| | Catalyst | treatment time | Synthesis gas | temperature | time |
| Data | composition | (minutes) | CH₄(200)H₂(800) | (° C.) | (minutes) |
| Example1 | Mg:Co:Mo = 0.99:0.075:0.025 | 20 | when temperature-raising- | 1000 | 30 |
| | | | synthetic gas, | | |
| | | | when temperature-lowering- | | |
| | | | hydrogen gas | | |
| Example2 | Mg:Co:Mo = 0.99:0.05:0.025 | 20 | when temperature-raising- | 900 | 60 |
| | | | synthetic gas, | | |
| | | | when temperature-lowering- | | |
| | | | hydrogen gas | | |
| Example3 | Mg:Co:Mo = 0.99:0.075:0.025 | 20 | when temperature-raising- | 900 | 60 |
| | | | synthetic gas, | | |
| | | | when temperature-lowering- | | |
| | | | hydrogen gas | | |
| Example4 | Mg:Co:Mo = 0.99:0.075:0.025 | 20 | when temperature-raising- | 900 | 90 |
| | | | synthetic gas, | | |
| | | | when temperature-lowering- | | |
| | | | hydrogen gas | | |
| Example5 | Mg:Co:Mo = 0.99:0.075:0.025 | 30 | when temperature-raising- | 1000 | 30 |
| | | | synthetic gas, | | |
| | | | when temperature-lowering- | | |
| | | | hydrogen gas | | |
| Comparative | Mg:Co:Mo = 0.99:0.125:0.025 | 20 | when temperature-raising- | 1000 | 30 |
| Example1 | | | synthetic gas, | | |
| | | | when temperature-lowering- | | |
| | | | hydrogen gas | | |
| Comparative | Mg:Co:Mo = 0.99:0.075:0.025 | 20 | when temperature-raising- | 1000 | 30 |
| Example2 | | | argon gas, | | |
| | | | when temperature-lowering- | | |
| | | | argon gas | | |
| Comparative | Mg:Fe:Mo = 0.99:0.075:0.025 | 20 | when temperature-raising- | 1000 | 30 |
| Example3 | | | synthetic gas, | | |
| | | | when temperature-lowering- | | |
| | | | hydrogen gas | | |

TABLE 2

| | Yield per 1 g | | | Peak in a pair |
|---|---|---|---|---|
| | of a catalyst | C purity | D/G | expression of |
| Data | (%) | (%, TGA) | ratio | RBM mode |
| Example1 | 178.4 | 64.34 | 0.0712 | ◯ |
| Example2 | 203.93 | 76.62 | 0.082903 | ◯ |
| Example3 | 220.43 | 74.34 | 0.111298 | ◯ |
| Example4 | 174.1 | 69.85 | 0.076105 | ◯ |
| Example5 | 165.37 | 61.04 | 0.064163 | ◯ |
| Comparative | 170.23 | 61.91 | 0.106032 | X |
| Example1 | | | | |
| Comparative | 29.97 | 34.68 | 0.20916 | X |
| Example2 | | | | |
| Comparative | 18.4 | — | 0.219925 | X |
| Example3 | | | | |

As shown from in tables 1 and 2, yield per 1 g of the supported catalyst manufactured based on the catalyst composition of table 1 is more than or equal to 150%. Thus, it is recognized that the synthesis efficiency of carbon nanotubes has improved.

Also, it is confirmed that purity (C-purity) of carbon nanotubes manufactured by Examples 1 to 5 is excellent by being 60% or more, the intensity ratio thereof (ID/IG) is less than 0.12, and 2 peaks in a pair are appeared in the RBM mode as shown on FIG. 4.

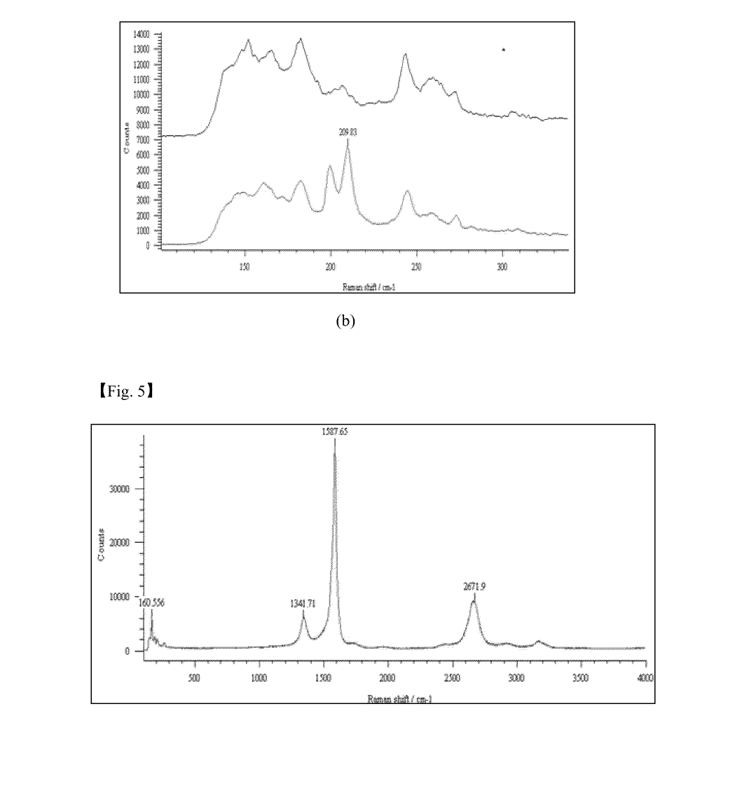

Otherwise, it is recognized that the intensity ratio of D band to G band (ID/IG) of carbon nanotubes manufactured by Example 1 is 0.712, but the intensity thereof by Comparative Example 1 has increased to 0.106. This result shows the crystallinity of carbon nanotubes in Comparative Example 1 is lower compared to that of Example 1, since there are plenty of disordered graphite and amorphous carbons which are conventionally generated in carbon nanotubes during a chemical deposition process. Also, it is confirmed that only single peak is appeared in the RBM mode as FIG. 5.

It is recognized that the yield and purity to carbon of carbon nanotubes based on Comparative Example 2 was rapidly reduced compared to Example 1. Also, the intensity ratio (ID/IG) through raman spectroscopy has remarkably increased to 0.209.

The yield of carbon nanotubes based on Comparative Example 3 has been reduced to below 20% of the yield of carbon nanotubes based on Example 1, and raman spectroscopy data shows intensity ratio (ID/IG) thereof has highly increased to 0.220.

1. A method for manufacturing double-wall carbon nanotubes comprising:
a preparatory step of a supported catalyst;
a temperature-raising step of inserting the supported catalyst into a reactor, injecting hydrocarbon gas and hydrogen gas at the same time, and raising the temperature of the reactor to between 900 to 1000° C. to synthesize carbon nanotubes; and
a temperature-lowering step of lowering the temperature of the reactor to between a room temperature to 200° C., injecting only hydrogen gas, and synthesizing carbon nanotubes.

2. A method for manufacturing double-wall carbon nanotubes according to claim 1, wherein the supported catalyst is manufactured by calcining an aqueous catalyst solution which is a mixture of a metal catalyst and a support at a molar ratio as below, in a reactor at a temperature of 500 to 800° C.:
Support [Mg]:Metal catalyst [Co]:Molybdenum-based activator [Mo]=0.99:x:0.025
wherein, 0.05≦x≦0.075].

3. A method for manufacturing double-wall carbon nanotubes according to claim 2, wherein the supported catalyst is a metal catalyst supported in a porous amorphous support, and the size of the metal catalyst is less than or equal to 5 nm.

4. A method for manufacturing double-wall carbon nanotubes according to claim 2, wherein the double-wall carbon nanotubes are manufactured by calcining at the temperature of 500 to 800° C. for 20 to 60 minutes.

5. A method for manufacturing double-wall carbon nanotubes according to claim 2, further comprising a step of increasing the surface area of a catalyst by grinding the calcined supported catalyst.

6. A method for manufacturing double-wall carbon nanotubes according to claim 1, wherein the temperature of the reactor is raised between 900 to 1000° C., and is maintained for 30 to 90 minutes in the temperature-raising step.

7. A method for manufacturing double-wall carbon nanotubes according to claim 1, wherein the injection speed of hydrocarbon gas is 200 to 300 sccm in the temperature-raising step, and the injection speed of hydrogen gas is 700 to 900 sccm in the temperature-raising step and the temperature-lowering step.

8. A method for manufacturing double-wall carbon nanotubes according to claim 1, wherein the hydrocarbon is selected from a group consisting of methane, ethylene, acetylene, LPG, and a mixed gas thereof.

9. A method for manufacturing double-wall carbon nanotubes according to claim 1, wherein a yield per l g of the supported catalyst is more than or equal to 100%.

10. Double-wall carbon nanotubes manufactured by a method for manufacturing carbon nanotubes according to claim 1.

11. Double-wall carbon nanotubes according to claim 10, wherein a purity (C-purity) of carbon nanotubes is more than or equal to 50%.

12. Double-wall carbon nanotubes according to claim 10, wherein two peaks in a pair are appeared in an RBM mode area.

13. Double-wall carbon nanotubes according to claim 10, wherein an intensity of D band to G band (ID/IG) of the carbon nanotubes through the raman spectroscopy is less than 0.15.

14. Double-wall carbon nanotubes, wherein the intensity of D band to G band (ID/IG) is less than 0.15 and two peaks in a pair is appeared in an RBM mode area through raman spectroscopy.

15. Double-wall carbon nanotubes according to claim 14, further comprising the supported catalyst as below:
Support [Mg]:Metal catalyst [Co]:Molybdenum-based activator [Mo]=0.99:x:0.025
wherein, 0.05≦x≦0.075.

16. Double-wall carbon nanotubes according to claim 15, wherein the supported catalyst is a metal catalyst supported in a porous amorphous support, and the size of the metal catalyst is less than or equal to 5 nm.

17. Double-wall carbon nanotubes according to claim 14, wherein a purity (C-purity) of carbon nanotubes is more than or equal to 50%.
